(19) United States
(12) Patent Application Publication
(10) Pub. No.: US 2020/0035973 A1
(43) Pub. Date: Jan. 30, 2020

(54) SECONDARY BATTERY AND METHOD FOR MANUFACTURING THE SAME

(71) Applicant: NEC CORPORATION, Tokyo (JP)

(72) Inventor: Toshihiko MANKYUU, Tokyo (JP)

(73) Assignee: NEC CORPORATION, Tokyo (JP)

(21) Appl. No.: 16/497,666

(22) PCT Filed: Mar. 9, 2018
(86) PCT No.: PCT/JP2018/009240

§ 371 Date: Sep. 25, 2019

(30) Foreign Application Priority Data
Mar. 28, 2017 (JP) 2017-062558

(51) Int. Cl. H01M 2/16; H01M 10/0525

(52) U.S. Cl. CPC H01M 2/1673; H01M 2/1686; H01M 10/0525

(57) ABSTRACT

The present invention provides a secondary battery and a method for manufacturing the same capable of maintaining high insulation between electrodes and more effectively suppressing internal short circuit. The secondary battery has a positive electrode, a negative electrode disposed to face the positive electrode, and a separator disposed between the positive electrode and the negative electrode. Each of the positive electrode and the negative electrode comprises a current collector and an active material layer formed on at least one surface of the current collector, and at least one of the positive electrode and the negative electrode further comprises an insulating layer formed on the surface of the active material layer. The separator has a thermal shrinkage rate of less than 5% at 200° C. and a Gurley value of 10 seconds/100 ml or less.

### TECHNICAL FIELD

The present invention relates to a secondary battery in which at least one of a positive electrode and a negative electrode has an insulating layer on an active material layer, and a method for manufacturing the same.

### BACKGROUND ART

Secondary batteries are widely used as power sources for portable electronic devices such as smart phones, tablet computers, notebook computers, digital cameras, and the like. In addition, secondary batteries have been expanding their application as power sources for electric vehicles and household power supplies. Among them, since lithium ion secondary batteries are high in energy density and light in weight, they are indispensable energy storage devices for current life. In such secondary batteries having high energy density, high safety technology is required, and in particular, it is important to ensure safety for internal short circuits.

A conventional battery including a secondary battery has a structure in which a positive electrode and a negative electrode, which are electrodes, are opposed to each other with a separator interposed therebetween. The positive electrode and the negative electrode each have a sheet-like current collector and active material layers formed on both sides of the current collector. The separator serves to prevent a short circuit between the positive electrode and the negative electrode and to effectively move ions between the positive electrode and the negative electrode. Conventionally, a polyolefin system microporous separator made of polypropylene or polyethylene material is mainly used as the separator. However, the melting points of polypropylene and polyethylene materials are generally 110° C. to 160° C. Therefore, when a polyolefin system separator is used for a battery with a high energy density, the separator melts at a high temperature of the battery, and a short circuit may occur between the electrodes in a large area, which cause smoke and ignition of the battery.

Therefore, in order to improve the safety of the secondary battery, Patent Literature 1 (Japanese Patent Laid-Open No. 2003-123728) discloses a secondary battery in which a separator is composed of a non-woven fabric containing a specific amount of fibers having a specific diameter.

Patent Literature 2 (Re-publication of PCT International Publication No. WO 2005/067079) and patent Literature 3 (Re-publication of PCT International Publication No. WO 2005/098997) disclose a secondary battery in which at least one of a positive electrode and a negative electrode has a porous insulating film containing an inorganic oxide filler and a binder on a surface thereof. In particular, in the secondary battery described in Patent Literature 2, the separator is composed of a non-woven fabric, and in the secondary battery described in Patent Literature 3, the porosity of the separator and the porous insulating layer is optimized.

A separator made of a non-woven fabric can be expected as a separator, for example, suitable for high output at low temperature because of its good ion conductivity. Moreover, an insulating property at high temperature is improved by providing the porous insulating film on the surface of at least one of the positive electrode and the negative electrode.

### CITATION LIST

### Patent Literature

Patent Literature 1: Japanese Patent Laid-Open No. 2003-123728
Patent Literature 2: Re-publication of PCT International Publication No. WO 2005/067079
Patent Literature 3: Re-publication of PCT International Publication No. WO 2005/098997

### SUMMARY OF INVENTION

### Technical Problem

However, when a non-woven fabric is used as a separator, there is a possibility that an internal short circuit may occur due to a metal deposited in the electrolyte during charging, and minute projections or burrs of the electrode, etc. easily penetrating the separator, and thus it was difficult to ensure sufficient insulation with the separator alone. Therefore, it is conceivable to coat an insulating material such as alumina on the surface of the non-woven separator to prevent the internal short circuit during charging. However, in this case, the non-woven fabric is softened at high temperature of the battery and may be broken by an external force, and there is a possibility that insulation cannot be maintained.

On the other hand, when the porous insulating film formed on at least one of the positive electrode and the negative electrode is combined with the separator, if the separator has a large heat shrinkage rate, the separator shrinks by heat at high temperature of the battery, and the shrinkage of the separator may cause a possibility that the porous insulating film may be peeled off from the electrode surface. As a result, the insulation at high temperature cannot be maintained, and an internal short circuit occurs.

An object of the present invention is to provide a secondary battery and method for manufacturing the same capable of maintaining high insulation property between electrodes and more effectively suppressing internal short circuit.

### Solution to Problem

A secondary battery according to the present invention comprises:

a positive electrode,

a negative electrode disposed to face to the positive electrode, and

a separator disposed between the positive electrode and the negative electrode,

wherein each of the positive electrode and the negative electrode comprises a current collector and an active material layer formed on at least one surface of the current collector, and at least one of the positive electrode and the negative electrode further comprises an insulating layer formed on a surface of the active material layer, and

the separator has a heat shrinkage rate of less than 5% at 200° C. and a Gurley value of 10 seconds/100 ml or less.

A method for manufacturing a secondary battery according to the present invention comprises:

disposing a positive electrode and a negative electrode so as to face each other with a separator therebetween to constitute a battery element, and

enclosing the battery element together with an electrolytic solution in a casing,

wherein each of the positive electrode and the negative electrode comprises a current collector and an active material layer formed on at least one surface of the current collector, and at least one of the positive electrode and the negative electrode further comprises an insulating layer formed on a surface of the active material layer, and

the separator has a heat shrinkage rate of less than 5% at 200° C. and a Gurley value of 10 seconds/100 ml or less.

### Advantageous Effects of Invention

According to the present invention, high insulation property between the electrodes can be maintained and internal short circuit can be suppressed by combining the separator having specific physical properties and the insulating layer formed on at least one of the positive electrode and the negative electrode.

### BRIEF DESCRIPTION OF DRAWINGS

FIG. 1 is an exploded perspective view of a secondary battery according to one embodiment of the present invention.

FIG. 2 is a schematic sectional view of a battery element shown in FIG. 1.

FIG. 3 is a schematic sectional view showing the configuration of a positive electrode and a negative electrode shown in FIG. 2.

FIG. 4A is a sectional view showing an example of arrangement of the positive electrode and the negative electrode in the battery element.

FIG. 4B is a sectional view showing another example of arrangement of the positive electrode and the negative electrode in the battery element.

FIG. 5 is an exploded perspective view of a battery according to another embodiment of the present invention.

FIG. 6 is a schematic view showing an example of an electric vehicle equipped with a secondary battery.

FIG. 7 is a schematic diagram showing an example of a power storage device equipped with a secondary battery.

FIG. 8A is a graph showing temporal changes in battery voltage and temperature of each part in a nail penetration test of the secondary battery obtained in Example 1.

FIG. 8A is a graph showing temporal changes in battery voltage and temperature of each part in a nail penetration test of the secondary battery obtained in Comparative Example 1.

### Description of Embodiments

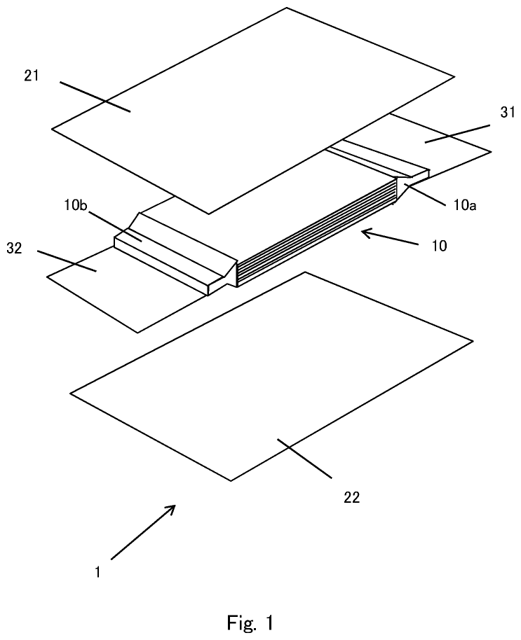

Referring to FIG. 1, an exploded perspective view of a secondary battery 1 according to one embodiment of the present invention is shown, which comprises a battery element 10 and a casing enclosing the battery element 10 together with an electrolytic solution. The casing has casing members 21, 22 that enclose the battery element 10 from both sides in the thickness direction thereof and seal outer circumferential portions thereof to thereby seal the battery element 10 and the electrolytic solution. A positive electrode terminal 31 and a negative electrode terminal 32 are respectively connected to the battery element 10 with protruding part of them from the casing.

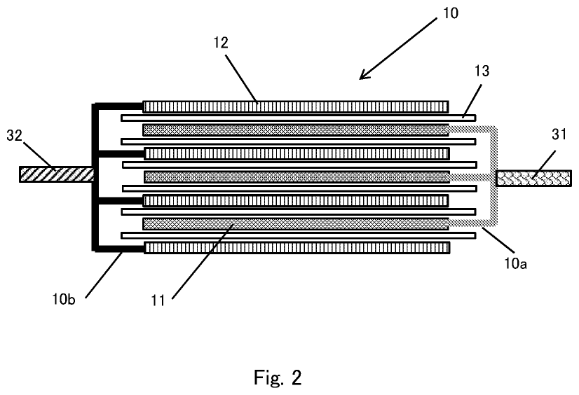

As shown in FIG. 2, the battery element 10 has a configuration in which a plurality of positive electrodes 11 and a plurality of negative electrodes 12 are disposed to face each other so as to be alternately positioned. In addition, a separator 13 is disposed between the positive electrode 11 and the negative electrode 12 to ensure ion conduction between the positive electrode 11 and the negative electrode 12 and to prevent a short circuit between the positive electrode 11 and the negative electrode 12.

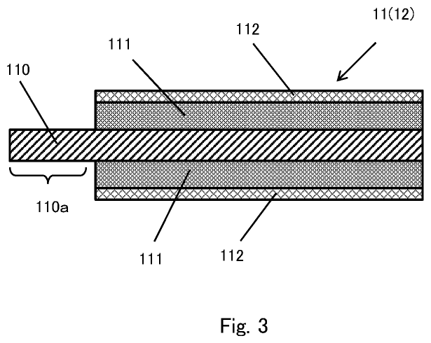

Structures of the positive electrode 11 and the negative electrode 12 will be described with further reference to FIG. 3. In the structure shown in FIG. 3, the positive electrode 11 and the negative electrode 12 are not particularly distinguished, but the structure is applicable to both the positive electrode 11 and the negative electrode 12. The positive electrode 11 and the negative electrode 12 (these may be collectively referred to as “electrode” in a case where these are not distinguished) include a current collector 110 which can be formed of a metal foil and an active material layer 111 formed on one or both surfaces of the current collector 110. The active material layer 111 is preferably formed in a rectangular shape in plan view, and the current collector 110 has a shape having an extended portion 110a extending from a region where the active material layer 111 is formed.

In a state where the positive electrode 11 and the negative electrode 12 are laminated, the extended portion 110a of the positive electrode 11 and the extended portion 110a of the negative electrode 12 are formed at a position overlapping with each other. However, the extension portions 110a of the positive electrode 11 are at positions overlapping with each other, and the extension portions 110a of the negative electrode 12 are the same. With such arrangement of the extended portions 110a, in the plurality of positive electrodes 11, the respective extended portions 110a are collected and welded together to form a positive electrode tab 10a. Likewise, in the plurality of negative electrodes 12, the respective extended portions 110a are collected and welded together to form a negative electrode tab 10b. A positive electrode terminal 31 is electrically connected to the positive electrode tab 10a and a negative electrode terminal 32 is electrically connected to the negative electrode tab 10b.

At least one of the positive electrode 11 and the negative electrode 12 further includes an insulating layer 112 formed on the active material layer 111. The insulating layer 112 is formed such that the active material layer 111 is not exposed in plan view. In the case where the active material layer 111 is formed on both surfaces of the current collector 110, the insulating layer 112 may be formed on both of the active material layers 111, or may be formed only on one of the active material layers 111.

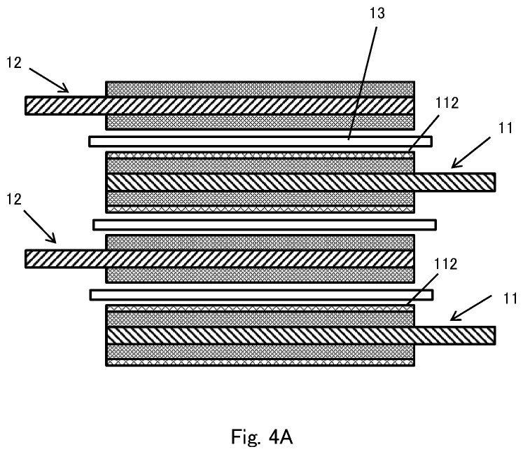

Some examples of the arrangement of the positive electrode 11 and the negative electrode 12 having such a structure are shown in FIGS. 4A and 4B. In the arrangement shown in FIG. 4A, the positive electrode 11 having the insulating layer 112 on both sides and the negative electrode 12 not having the insulating layer are alternately laminated. In the arrangement shown in FIG. 4B, the positive electrode 11 and the negative electrode 12 having the insulating layer 112 on only one side are alternately laminated in such a manner that the respective insulating layers 112 do not face each other.

The structure and arrangement of the positive electrode 11 and the negative electrode 12 are not limited to the above examples and various modifications are possible as long as the insulating layer 112 is provided on one surface of at least one of the positive electrode 11 and the negative electrode 12. For example, in the structures shown in FIGS. 4A and 4B, the relationship between the positive electrode 11 and the negative electrode 12 can be reversed.

Since the battery element 10 having a planar laminated structure as illustrated has no portion having a small radius of curvature (a region close to a winding core of a winding structure), the battery element 10 has an advantage that it is less susceptible to the volume change of the electrode due to charging and discharging as compared with the battery element having a wound structure. That is, the battery element having a planar laminated structure is effective for an electrode assembly using an active material that is liable to cause volume expansion.

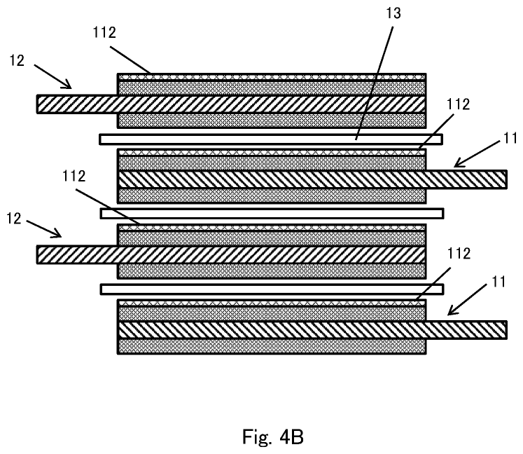

In the embodiment shown in FIGS. 1 and 2, the positive electrode terminal 31 and the negative electrode terminal 32 are drawn out in opposite directions, but the directions in which the positive electrode terminal 31 and the negative electrode terminal 32 are drawn out may be arbitrary. For example, as shown in FIG. 5, the positive electrode terminal 31 and the negative electrode terminal 32 may be drawn out from the same side of the battery element 10. Although not shown, the positive electrode terminal 31 and the negative electrode terminal 32 may also be drawn out from two adjacent sides of the battery element 10. In both of the above case, the positive electrode tab 10a and the negative electrode tab 10b can be formed at positions corresponding to the direction in which the positive electrode terminal 31 and the negative electrode terminal 32 are drawn out.

Furthermore, in the illustrated embodiment, the battery element 10 having a laminated structure having a plurality of positive electrodes 11 and a plurality of negative electrodes 12 is shown. However, the battery element having the winding structure may have one positive electrode 11 and one negative electrode 12.

Hereinafter, parts constituting the battery element 10 and the electrolytic solution will be described in detail. In the following description, although not particularly limited, elements in the lithium ion secondary battery will be described.
[1] Negative Electrode

The negative electrode has a structure in which, for example, a negative electrode active material is adhered to a negative electrode current collector by a negative electrode binder, and the negative electrode active material is laminated on the negative electrode current collector as a negative electrode active material layer. Any material capable of absorbing and desorbing lithium ions with charge and discharge can be used as the negative electrode active material in the present embodiment as long as the effect of the present invention is not significantly impaired. Normally, as in the case of the positive electrode, the negative electrode is also configured by providing the negative electrode active material layer on the current collector. Similarly to the positive electrode, the negative electrode may also have other layers as appropriate.

The negative electrode active material is not particularly limited as long as it is a material capable of absorbing and desorbing lithium ions, and a known negative electrode active material can be arbitrarily used. For example, it is preferable to use carbonaceous materials such as coke, acetylene black, mesophase microbead, graphite and the like; lithium metal; lithium alloy such as lithium-silicon, lithium-tin; lithium titanate and the like as the negative electrode active material. Among these, carbonaceous materials are most preferably used from the viewpoint of good cycle characteristics and safety and further excellent continuous charge characteristics. One negative electrode active material may be used alone, or two or more negative electrode active materials may be used in combination in any combination and ratio.

Furthermore, the particle diameter of the negative electrode active material is arbitrary as long as the effect of the present invention is not significantly impaired. However, in terms of excellent battery characteristics such as initial efficiency, rate characteristics, cycle characteristics, etc., the particle diameter is usually 1 μm or more, preferably 15 μm or more, and usually about 50 μm or less, preferably about 30 μm or less. Furthermore, for example, it can be also used as the carbonaceous material such as a material obtained by coating the carbonaceous material with an organic substance such as pitch or the like and then calcining the carbonaceous material, or a material obtained by forming amorphous carbon on the surface using the CVD method or the like. Examples of the organic substances used for coating include coal tar pitch from soft pitch to hard pitch; coal heavy oil such as dry distilled liquefied oil; straight run heavy oil such as atmospheric residual oil and vacuum residual oil, crude oil; petroleum heavy oil such as decomposed heavy oil (for example, ethylene heavy end) produced as a by-product upon thermal decomposition of crude oil, naphtha and the like. A residue obtained by distilling these heavy oil at 200 to 400° C. and then pulverized to a size of 1 to 100 μm can also be used as the organic substance. In addition, vinyl chloride resin, phenol resin, imide resin and the like can also be used as the organic substance.

In one embodiment of the present invention, the negative electrode includes a metal and/or a metal oxide and carbon as the negative electrode active material. Examples of the metal include Li, Al, Si, Pb, Sn, In, Bi, Ag, Ba, Ca, Hg, Pd, Pt, Te, Zn, La, and alloys of two or more of these. These metals or alloys may be used as a mixture of two or more. In addition, these metals or alloys may contain one or more non-metal elements.

Examples of the metal oxide include silicon oxide, aluminum oxide, tin oxide, indium oxide, zinc oxide, lithium oxide, and composites of these. In the present embodiment, tin oxide or silicon oxide is preferably contained as the negative electrode active material, and silicon oxide is more preferably contained. This is because silicon oxide is relatively stable and hardly causes reaction with other compounds. Also, for example, 0.1 to 5 mass % of one or more elements selected from nitrogen, boron and sulfur can be added to the metal oxide. In this way, the electrical conductivity of the metal oxide can be improved. Also, the electrical conductivity can be similarly improved by coating the metal or the metal oxide with an electro-conductive material such as carbon by vapor deposition or the like.

Examples of the carbon include graphite, amorphous carbon, diamond-like carbon, carbon nanotube, and composites of these. Highly crystalline graphite has high electrical conductivity and is excellent in adhesiveness with respect to a negative electrode current collector made of a metal such as copper and voltage flatness. On the other hand, since amorphous carbon having a low crystallinity has a relatively small volume expansion, it has a high effect of alleviating the volume expansion of the entire negative electrode, and deterioration due to non-uniformity such as crystal grain boundaries and defects hardly occurs.

The metal and the metal oxide have the feature that the capacity of accepting lithium is much larger than that of carbon. Therefore, the energy density of the battery can be improved by using a large amount of the metal and the metal oxide as the negative electrode active material. In order to achieve high energy density, it is preferable that the content ratio of the metal and/or the metal oxide in the negative electrode active material is high. A larger amount of the metal and/or the metal oxide is preferable, since it increases the capacity of the negative electrode as a whole. The metal and/or the metal oxide is preferably contained in the negative electrode in an amount of 0.01% by mass or more of the negative electrode active material, more preferably 0.1% by mass or more, and further preferably 1% by mass or more. However, the metal and/or the metal oxide has large volume change upon absorbing and desorbing of lithium as compared with carbon, and electrical junction may be lost. Therefore, the amount of the metal and/or the metal oxide in the negative active material is 99% by mass or less, preferably 90% by mass or less, more preferably 80% by mass or less. As described above, the negative electrode active material is a material capable of reversibly absorbing and desorbing lithium ions with charge and discharge in the negative electrode, and does not include other binder and the like.

For example, the negative electrode active material layer may be formed into a sheet electrode by roll-forming the above-described negative electrode active material, or may be formed into a pellet electrode by compression molding. However, usually, as in the case of the positive electrode active material layer, the negative electrode active material layer can be formed by applying and drying an application liquid on a current collector, where the application liquid may be obtained by slurrying the above-described negative electrode active material, a binder, and various auxiliaries contained as necessary with a solvent.

The negative electrode binder is not particularly limited, and examples thereof include polyvinylidene fluoride, vinylidene fluoride-hexafluoropropylene copolymer, vinylidene fluoride-tetrafluoroethylene copolymer, styrene-butadiene copolymer rubber, polytetrafluoroethylene, polypropylene, polyethylene, acrylic, polyimide, polyamide imide and the like. In addition to the above, styrene butadiene rubber (SBR) and the like can be included. When an aqueous binder such as an SBR emulsion is used, a thickener such as carboxymethyl cellulose (CMC) can also be used. The amount of the negative electrode binder to be used is preferably 0.5 to 20 parts by mass relative to 100 parts by mass of the negative electrode active material from the viewpoint of a trade-off between “sufficient binding strength” and “high energy”. The negative electrode binders may be mixed and used.

As the material of the negative electrode current collector, a known material can be arbitrarily used, and for example, a metal material such as copper, nickel, stainless steel, aluminum, chromium, silver and an alloy thereof is preferably used from the viewpoint of electrochemical stability. Among them, copper is particularly preferable from the viewpoint of ease of processing and cost. It is also preferable that the negative electrode current collector is also subjected to surface roughening treatment in advance. Further, the shape of the current collector is also arbitrary, and examples thereof include a foil shape, a flat plate shape and a mesh shape. A perforated type current collector such as an expanded metal or a punching metal can also be used.

The negative electrode can be produced, for example, by forming a negative electrode active material layer containing a negative electrode active material and a negative electrode binder on a negative electrode current collector. Examples of a method for forming the negative electrode active material layer include a doctor blade method, a die coater method, a CVD method, a sputtering method, and the like. After forming the negative electrode active material layer in advance, a thin film of aluminum, nickel or an alloy thereof may be formed by a method such as vapor deposition, sputtering or the like to obtain a negative electrode current collector.

An electroconductive auxiliary material may be added to a coating layer containing the negative electrode active material for the purpose of lowering the impedance. Examples of the electroconductive auxiliary material include flaky, sooty, fibrous carbonaceous microparticles and the like such as graphite, carbon black, acetylene black, vapor grown carbon fiber (for example, VGCF (registered trademark) manufactured by Showa Denko K.K.), and the like.
[2] Positive Electrode

The positive electrode refers to an electrode on the high potential side in a battery. As an example, the positive electrode includes a positive electrode active material capable of reversibly absorbing and desorbing lithium ions with charge and discharge, and has a structure in which a positive electrode active material is laminated on a current collector as a positive electrode active material layer integrated with a positive electrode binder. In one embodiment of the present invention, the positive electrode has a charge capacity per unit area of 3 mAh/cm² or more, preferably 3.5 mAh/cm² or more. From the viewpoint of safety and the like, the charge capacity per unit area of the positive electrode is preferably 15 mAh/cm² or less. Here, the charge capacity per unit area is calculated from the theoretical capacity of the active material. That is, the charge capacity of the positive electrode per unit area is calculated by (theoretical capacity of the positive electrode active material used for the positive electrode)/(area of the positive electrode). Note that the area of the positive electrode refers to the area of one surface, not both surfaces of the positive electrode.

The positive electrode active material in the present embodiment is not particularly limited as long as it is a material capable of absorbing and desorbing lithium, and can be selected from several viewpoints. A high-capacity compound is preferably contained from the viewpoint of high energy density. Examples of the high-capacity compound include nickel lithate (LiNiO₂) and a lithium nickel composite oxide obtained by partially replacing Ni of nickel lithate with another metal element, and a layered lithium nickel composite oxide represented by formula (A) below is preferable.

Li_{y}Ni₍₁₋ₓ₎MₓO₂ (A)

(provided that 0≤x<1, 0<y≤1.2, and M is at least one element selected from the group consisting of Co, Al, Mn, Fe, Ti, and B.)

From the viewpoint of high capacity, the Ni content is preferably high, or that is to say, x is less than 0.5 in formula (A), and more preferably 0.4 or less. Examples of such compounds include Li_{α}Ni_{β}Co_{γ}Mn_{δ}O₂ (0<α≤1.2, preferably 1≤α≤1.2, β+γ+δ=1, β≥0.7, and γ≤0.2) and Li_{α}Ni_{β}Co_{γ}Al_{δ}O₂ (0<α≤1.2 preferably 1≤α≤1.2, β+γ+δ=1, β≥0.6 preferably β≥0.7, γ≤0.2), and, in particular, LiNi_{β}Co_{γ}Mn_{δ}O₂ (0.75≤β≤0.85, 0.05≤γ≤0.15, 0.10≤δ≤0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, and LiNi_{0.8}Co_{0.1}Al_{0.1}O₂ can be preferably used.

From the viewpoint of heat stability, it is also preferable that the Ni content does not exceed 0.5, or that is to say, x is 0.5 or more in formula (A). It is also preferable that a certain transition metal does not account for more than half. Examples of such compounds include Li_{α}Ni_{β}Co_{γ}Mn_{δ}O₂ (0<α≤1.2 preferably 1≤α≤1.2, β+γ+δ=1, 0.2≤β≤0.5, 0.1≤γ≤0.4, 0.1≤δ≤0.4). More specific examples include LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), and LiNi_{0.5}Co_{0.3}Mn_{0.2}O₂ (abbreviated as NCM532) (provided that these compounds include those in which the content of each transition metal is varied by about 10%).

Also, two or more compounds represented by formula (A) may be used as a mixture, and, for example, it is also preferable to use NCM532 or NCM523 with NCM433 in a range of 9:1 to 1:9 (2:1 as a typical example) as a mixture. Moreover, a battery having a high capacity and a high heat stability can be formed by mixing a material having a high Ni content (x is 0.4 or less) with a material having a Ni content not exceeding 0.5 (x is 0.5 or more, such as NCM433) in formula (A).

Other than the above positive electrode active materials, examples include lithium manganates having a layered structure or a spinel structure, such as LiMnO₂, LiₓMn₂O₄ (0<x<2), Li₂MnO₃, and LiₓMn_{1.5}Ni_{0.5}O₄ (0<x<2); LiCoO₂ and those obtained by partially replacing these transition metals with other metals; those having an excess of Li based on the stoichiometric compositions of these lithium transition metal oxides; and those having an olivine structure such as LiFePO₄. Moreover, materials obtained by partially replacing these metal oxides with Al, Fe, P, Ti, Si, Pb, Sn, In, Bi, Ag, Ba, Ca, Hg, Pd, Pt, Te, Zn, La, or the like can be used as well. One of the positive electrode active materials described above may be used singly, or two or more can be used in combination.

A positive electrode binder similar to the negative electrode binder can be used. Among them, polyvinylidene fluoride or polytetrafluoroethylene is preferable from the viewpoint of versatility and low cost, and polyvinylidene fluoride is more preferable. The amount of the positive electrode binder used is preferably 2 to 15 parts by mass relative to 100 parts by mass of the positive electrode active material from the viewpoint of a trade-off between “sufficient binding strength” and “high energy”.

An electroconductive auxiliary material may be added to a coating layer containing the positive electrode active material for the purpose of lowering the impedance. Examples of the conductive auxiliary material include flaky, sooty, fibrous carbonaceous microparticles and the like such as graphite, carbon black, acetylene black, vapor grown carbon fiber (for example, VGCF manufactured by Showa Denko K.K.) and the like.

A positive electrode current collector similar to the negative electrode current collector can be used. In particular, as the positive electrode, a current collector using aluminum, an aluminum alloy, iron, nickel, chromium, molybdenum type stainless steel is preferable.
[3] Insulating Layer

### (Material and Manufacturing Method etc.)

The insulating layer can be formed by applying a slurry composition for an insulating layer so as to cover a part of the active material layer of the positive electrode or the negative electrode and drying and removing a solvent. Although the insulating layer may be formed on only one side of the active material layer, there is an advantage that the warpage of the electrode can be reduced by forming the insulating layer on both side (in particular, as a symmetrical structure).

A slurry for the insulating layer is a slurry composition for forming a porous insulating layer. Therefore, the “insulating layer” can also be referred to as “porous insulating layer”. The slurry for the insulating layer comprises non-conductive particles and a binder (or a binding agent) having a specific composition, and the non-conductive particles, the binder and optional components are uniformly dispersed as a solid content in a solvent.

It is desirable that the non-conductive particles stably exist in the use environment of the lithium ion secondary battery and are electrochemically stable. As the non-conductive particles, for example, various inorganic particles, organic particles and other particles can be used. Among them, inorganic oxide particles or organic particles are preferable, and in particular, from the viewpoint of high thermal stability of the particles, it is more preferable to use inorganic oxide particles. Metal ions in the particles sometimes form salts near the electrode, which may cause an increase in the internal resistance of the electrode and a decrease in cycle characteristics of the secondary battery. The other particles include particles to which conductivity is given by surface treatment of the surface of fine powder with a non-electrically conductive substance. The fine powder can be made from a conductive metal, compound and oxide such as carbon black, graphite, SnO₂, ITO and metal powder. Two or more of the above-mentioned particles may be used in combination as the non-conductive particles.

Examples of the inorganic particles include inorganic oxide particles such as aluminum oxide, silicon oxide, magnesium oxide, titanium oxide, BaTiO₂, ZrO, alumina-silica composite oxide; inorganic nitride particles such as aluminum nitride and boron nitride; covalent crystal particles such as silicone, diamond and the like; sparingly soluble ionic crystal particles such as barium sulfate, calcium fluoride, barium fluoride and the like; clay fine particles such as talc and montmorillonite. These particles may be subjected to element substitution, surface treatment, solid solution treatment, etc., if necessary, and may be used singly or in combination of two or more kinds. Among them, inorganic oxide particles are preferable from the viewpoints of stability in the electrolytic solution and potential stability.

The shape of the non-conductive particles is not particularly limited, and may be spherical, needle-like, rod-like, spindle-shaped, plate-like, or the like. From the viewpoint of effectively preventing penetration of the needle-shaped object, the shape of the inorganic particle may be in the form of a plate.

When the shape of the non-conductive particles is plate-like, it is preferable to orient the non-conductive particles in the porous film so that the flat surfaces thereof are substantially parallel to the surface of the porous film. By using such a porous film, the occurrence of a short circuit of the battery can be suppressed better. By orienting the non-conductive particles as described above, it is conceivable that the non-conductive particles are arranged so as to overlap with each other on a part of the flat surface, and voids (through holes) from one surface to the other surface of the porous film are formed not in a straight but in a bent shape (that is, the curvature ratio is increased). This is presumed to prevent the lithium dendrite from penetrating the porous film and to better suppress the occurrence of a short circuit.

Examples of the plate-like non-conductive particles, especially inorganic particles, preferably used include various commercially available products such as “SUNLOVELY” (SiO₂) manufactured by AGC Si-Tech Co., Ltd., pulverized product of “NST-B 1” (TiO₂) manufactured by Ishihara Sangyo Kaisha, Ltd., plate like barium sulfate “H series”, “HL series” manufactured by Sakai Chemical Industry Co., Ltd., “Micron White” (Talc) manufactured by Hayashi Kasei Co., Ltd., “Benger” (bentonite) manufactured by Hayashi Kasei Co., Ltd., “BMM” and “BMT” (boehmite) manufactured by Kawaii Lime Industry Co., Ltd., “Serasur BMT-B” [alumina (Al₂O₃)] manufactured by Kawaii Lime Industry Co., Ltd., “Serath” (alumina) manufactured by Kinsei Matec Co., Ltd., “AKP series” (alumina) manufactured by Sumitomo Chemical Co., Ltd., and “Hikawa Mica Z-20” (sericite) manufactured by Hikawa Mining Co., Ltd. In addition, SiO₂, Al₂O₃, and ZrO can be produced by the method disclosed in Japanese Patent Laid-Open No. 2003-206475.

When the shape of the non-conductive particles is spherical, the average particle diameter of the non-conductive particles is preferably in the range of 0.005 to 10 μm, more preferably 0.1 to 5 μm , particularly preferably 0.3 to 2 μm. When the average particle diameter of the non-conductive particles is in the above range, the dispersion state of the porous film slurry is easily controlled, so that it is easy to manufacture a porous film having a uniform and predetermined thickness. In addition, such average particle diameter provides the following advantages. The adhesion to the binder is improved, and even when the porous film is wound, it is possible to prevent the non-conductive particles from peeling off, and as a result, sufficient safety can be achieved even if the porous film is thinned. Since it is possible to suppress an increase in the particle packing ratio in the porous film, it is possible to suppress a decrease in ion conductivity in the porous film. Furthermore, the porous membrane can be made thin.

The average particle diameter of the non-conductive particles can be obtained by arbitrarily selecting 50 primary particles from an SEM (scanning electron microscope) image in an arbitrary field of view, carrying out image analysis, and obtaining the average value of circle equivalent diameters of each particle.

The particle diameter distribution (CV value) of the non-conductive particles is preferably 0.5 to 40%, more preferably 0.5 to 30%, particularly preferably 0.5 to 20%. By setting the particle diameter distribution of the non-conductive particles within the above range, a predetermined gap between the non-conductive particles is maintained, so that it is possible to suppress an increase in resistance due to the inhibition of movement of lithium. The particle diameter distribution (CV value) of the non-conductive particles can be determined by observing the non-conductive particles with an electron microscope, measuring the particle diameter of 200 or more particles, determining the average particle diameter and the standard deviation of the particle diameter, and calculating (Standard deviation of particle diameter)/(average particle diameter). The larger the CV value means the larger variation in particle diameter.

When the solvent contained in the slurry for insulating layer is a non-aqueous solvent, a polymer dispersed or dissolved in a non-aqueous solvent can be used as a binder. As the polymer dispersed or dissolved in the non-aqueous solvent, polyvinylidene fluoride (PVdF), polytetrafluoroethylene (PTFE), polyhexafluoropropylene (PHFP), polytrifluoroethylene chloride (PCTFE), polyperfluoroalkoxyfluoroethylene, polyimide, polyamideimide, and the like can be used as a binder, and it is not limited thereto.

In addition, a binder used for binding the active material layer can also be used.

When the solvent contained in the slurry for insulating layer is an aqueous solvent (a solution using water or a mixed solvent containing water as a main component as a dispersion medium of the binder), a polymer dispersed or dissolved in an aqueous solvent can be used as a binder. A polymer dispersed or dissolved in an aqueous solvent includes, for example, an acrylic resin. As the acrylic resin, it is preferably to use homopolymers obtained by polymerizing monomers such as acrylic acid, methacrylic acid, acrylamide, methacrylamide, 2-hydroxyethyl acrylate, 2-hydroxyethyl methacrylate, methyl methacrylate, ethylhexyl acrylate, butyl acrylate. The acrylic resin may be a copolymer obtained by polymerizing two or more of the above monomers. Further, two or more of the homopolymer and the copolymer may be mixed. In addition to the above-mentioned acrylic resin, polyolefin resins such as styrene butadiene rubber (SBR) and polyethylene (PE), polytetrafluoroethylene (PTFE), and the like can be used. These polymers can be used singly or in combination of two or more kinds. Among them, it is preferable to use an acrylic resin. The form of the binder is not particularly limited, and particles in the form of particles (powder) may be used as they are, or those prepared in a solution state or an emulsion state may be used. Two or more kinds of binders may be used in different forms.

The insulating layer may contain a material other than the above-described non-conductive filler and binder, if necessary. Examples of such material include various polymer materials that can function as a thickener for a slurry for the insulating layer, which will be described later. In particular, when an aqueous solvent is used, it is preferable to contain a polymer functioning as the thickener. As the polymer functioning as the thickener, carboxymethyl cellulose (CMC) or methyl cellulose (MC) is preferably used.

Although not particularly limited, the ratio of the non-conductive filler to the entire insulating layer is suitably about 70 mass % or more (for example, 70 mass % to 99 mass %), preferably 80 mass % or more (for example, 80 mass % to 99 mass %), and particularly preferably about 90 mass % to 95 mass %.

The ratio of the binder in the insulating layer is suitably about 1 to 30 mass % or less, preferably 5 to 20 mass % or less. In the case of containing an insulating layer-forming component other than the inorganic filler and the binder, for example, a thickener, the content ratio of the thickener is preferably about 10 mass % or less, more preferably about 7 mass % or less. If the ratio of the binder is too small, strength (shape retentivity) of the insulating layer itself and adhesion to the active material layer are lowered, which may cause defects such as cracking and peeling. If the ratio of the binder is too large, gaps between the particles of the insulating layer become insufficient, and the ion permeability in the insulating layer may decrease in some cases.

In order to maintain ion conductivity, the porosity (void ratio) (the ratio of the pore volume to the apparent volume) of the insulating layer is preferably 20% or more, more preferably 30% or more. However, if the porosity is too high, falling off or cracking of the insulating layer due to friction or impact applied to the insulating layer occurs, the porosity is preferably 80% or less, more preferably 70% or less.

The porosity can be calculated from the ratio of the materials constituting the insulating layer, the true specific gravity and the coating thickness.

When the average particle diameter of the non-conductive particles is D (μm) and the porosity of the insulating layer is P, the vacancy index represented by D×P is preferably 0.4 or less. The smaller the particle diameter of the non-conductive particles, the more often the dendrite contacts the particles during dendrite growth, and some dendrites diverge in the lateral direction or diverge in the opposite direction with each contact. As a result, the growth of dendrite in the laminated direction of the insulating layer is suppressed. Also, from the viewpoint of the porosity of the insulating layer, comparing the growth of dendrites between insulating layers having the same particle diameter of non-conductive particles, the smaller the porosity, the more often the dendrite contacts the particles during the growth of dendrites. As a result, growth of dendrite in the laminated direction of the insulating layer is suppressed as described above.

As described above, the particle diameter of the non-conductive particles and the porosity of the insulating layer greatly affect the growth direction of the dendrite. Therefore, a value obtained by multiplying the average particle diameter D of the non-conductive particles and the porosity P of the insulating layer can be used as an index for suppressing the growth of dendrite in the laminated direction of the insulating layer. As a result of investigation by the present inventor, it has been found that the dendrite growth in the laminated direction of the insulating layer can be effectively suppressed by arranging the non-conductive particles in the insulating layer so that D x PA.4. Thereby, the internal short circuit during charging of the battery can be effectively suppressed.

### (Forming of Insulating Layer)

A method of forming the insulating layer will be described. As a material for forming the insulating layer, a paste type material (including slurry form or ink form, the same applies below) mixed and dispersed with an non-conductive filler, a binder and a solvent can be used.

A solvent used for the insulating layer slurry includes water or a mixed solvent mainly containing water. As a solvent other than water constituting such a mixed solvent, one or more kinds of organic solvents (lower alcohols, lower ketones, etc.) which can be uniformly mixed with water can be appropriately selected and used. Alternatively, it may be an organic solvent such as N-methylpyrrolidone (NMP), pyrrolidone, methyl ethyl ketone, methyl isobutyl ketone, cyclohexanone, toluene, dimethylformamide, dimethylacetamide, or a combination of two or more thereof. The content of the solvent in the slurry for the insulating layer is not particularly limited, and it is preferably 40 to 90 mass %, particularly preferably about 50 to 70 mass %, of the entire coating material.

The operation of mixing the non-conductive filler and the binder with the solvent can be carried out by using a suitable kneading machine such as a ball mill, a homodisper, Disper Mill (registered trademark), Clearmix (registered trademark), Filmix (registered trademark), an ultrasonic dispersing machine.

For the operation of applying the slurry for the insulating layer, conventional general coating means can be used without restricting. For example, a predetermined amount of the slurry for the insulating layer can be applied by coating in a uniform thickness by means of a suitable coating device (a gravure coater, a slit coater, a die coater, a comma coater, a dip coater, etc.).

Thereafter, the solvent in the slurry for the insulating layer may be removed by drying the coating material by means of a suitable drying means.

### (Thickness)

The thickness of the insulating layer is preferably 1 μm or more and 30 μm or less, and more preferably 2 μm or more and 15 μm or less.
[4] Electrolytic Solution

The electrolytic solution includes, but are not particularly limited, a nonaqueous electrolytic solution which is stable at an operating potential of the battery. Specific examples of the nonaqueous electrolytic solution include nonprotic organic solvent such as cyclic carbonates such as propylene carbonate (PC), ethylene carbonate (EC), fluoroethylene carbonate (FEC), t-difluoroethylene carbonate (t-DFEC), butylene carbonate (BC), vinylene carbonate (VC), vinylethylene carbonate (VEC); chain carbonates such as allylmethyl carbonate (AMC), dimethyl carbonate (DMC), diethyl carbonate (DEC), ethylmethyl carbonate (EMC), clipropyl carbonate (DPC); propylene carbonate derivative; aliphatic carboxylic acid esters such as methyl formate, methyl acetate, ethyl propionate; cyclic esters such as ⊐-butyrolactone (GBL). The nonaqueous electrolytic solution may be used singly or a mixture of two or more kinds may be used in combination. Furthermore, sulfur-containing cyclic compound such as sulfolane, fluorinated sulfolane, propane sultone or propene sultone may be used.

Specific examples of support salt contained in the electrolytic solution include, but are not particularly limited to, lithium salt such as LiPF6, LiAsF6, LiAlCl4, LiClO4, LiBF4, LiSbF6, LiCF3SO3, LiC4F9SO3, Li (CF3SO2)2, LiN (CF3SO2)2. The support salt may be used singly or two or more kinds thereof may be used in combination.
[5] Separator

The separator 13 is configured such that the heat shrinkage rate at 200° C. is less than 5%, and the Gurley value is 10 seconds/100 ml or less. By using a separator with a very low heat shrinkage rate at high temperature, it is possible to suppress damage to the insulating layer by the separator, such as peeling of the insulating layer from the active material layer due to shrinkage of the separator and being dragged by the separator at high temperature of the battery as described above.

On the other hand, a separator with a small heat shrinkage rate generally has a low Gurley value, and when a separator with a small heat shrinkage rate is used for insulation between electrodes, there is a possibility that the battery cannot be charged due to a minute internal short circuit due to the growth of metal dendrite deposited during charging. In order to prevent this, it is conceivable to use a thick separator, but when the thick separator is used, the distance between the electrodes becomes large, and the energy density is reduced. Therefore, by arranging a separator having a heat shrinkage rate of less than 5% at 200° C. and a Gurley value of 10 seconds/100 ml or less between the electrodes of which the insulating layer is formed on the surface, the effect of the insulating layer itself can be sufficiently exhibited without causing a decrease in energy density.

The material of the separator is not particularly limited as long as it can be configured such that the heat shrinkage rate at 200° C. is less than 5% and the Gurley value is 10 seconds/100 ml or less. As the separator, porous film or non-woven fabric made of such as polyethylene terephthalate (PET), fluorine-based resin, polyamide, polyimide, polyester, polyphenylene sulfide, as well as an article in which inorganic substance such as silica, alumina, glass is attached or bonded to a base material made of the above material and an article singly processed from the above material as non-woven fabric or cloth may be used. In particular, a separator made of non-woven fabric is preferable in that a separator having a low Gurley value can be easily obtained. Furthermore, these materials may be laminated to be used as the separator. The thickness of the separator may be arbitrary as long as the above Gurley value is satisfied. However, from the viewpoint of high energy density, a thin separator is preferable and the thickness can be, for example, 10 to 30 μm.

The Gurley value is an index related to air permeability of woven fabric and non-woven fabric, and is a value measured in conformity with JIS P8117. Lower Gurley value indicates higher air permeability. Generally, a separator having a relatively high Gurley value is used to prevent a short circuit between the positive electrode and the negative electrode, and the value is 100 seconds/100 ml or more.

The present invention is not limited to the above described lithium ion secondary battery and can be applied to any battery. However, since the problem of heat often occurs in batteries with high capacity in many cases, the present invention is preferably applied to batteries with high capacity, particularly lithium ion secondary batteries.

Next, embodiments of method for manufacturing the electrode shown in FIG. 3 will be described. In the following description, the positive electrode 11 and the negative electrode 12 will be described as “electrodes” without particularly distinguishing from each other, but the positive electrode 11 and the negative electrode differ only in the materials, shapes, etc. to be used, and the following explanation will be made on the positive electrode 11 and the negative electrode 12.

The manufacturing method of the electrode is not particularly limited as long as the electrode can be formed to have a structure in which the active material layer 111 and the insulating layer 112 are laminated in this order on the current collector 110 finally.

The active material layer 111 can be formed by applying an mixture for an active material layer prepared by dispersing an active material and a binder in a solvent to form a slurry and drying the applied mixture for the active material layer. After the mixture for the active material layer is dried, the method may further include the step of compression-molding the dried mixture for the active material layer. The insulating layer 12 can also be formed in the same process as the active material layer 111. That is, the insulating layer 112 can be formed by applying an mixture for an insulating layer prepared by dispersing an insulating material and a binder in a solvent to form a slurry, and drying the applied mixture for the insulating layer. After the mixture for the insulating layer is dried, the method may further include the step of compression molding the dried mixture for the insulating layer.

The process for forming the active material layer 111 and the process for forming the insulating layer 112 described above may be carried out separately or in appropriate combination. Combining the forming process of the active material layer 111 and the forming process of the insulating layer 112 includes for example the following procedure: before drying the mixture for the active material layer applied on the current collector 110, the mixture for the insulating layer is applied on the applied mixture for the active material layer, and the whole of the mixture for the active material layer and the mixture for the insulating layer are simultaneously dried; after application and drying of the mixture for the active material layer, application and drying of the mixture for the insulating layer are performed thereon, and the whole of the mixture for the active material layer and the mixture for the insulating layer are simultaneously compression molded. By combining the formation process of the active material layer 111 and the formation process of the insulating layer 112, the manufacturing process of the electrode can be simplified.

Next, an example of a method for manufacturing a secondary battery will be described.

First, a positive electrode and a negative electrode are prepared, and a separator is prepared. The positive electrode and the negative electrode have a current collector and an active material layer formed on at least one surface of the current collector respectively, and at least one of the positive electrode and the negative electrode further comprises an insulating layer formed on the surface of the active material layer. In addition, the separator has a heat shrinkage rate of less than 5% at 200° C. and a Gurley value of 10 seconds/100 ml or less.

Then, the positive electrode and the negative electrode are arranged to face each other with the separator interposed therebetween to constitute a battery element. When the number of the positive electrode and the negative electrode is more than one, the positive electrode and the negative electrode are arranged so that the positive electrode and the negative electrode alternately face each other, and the separator is also prepared as many as necessary for arranging between the positive electrode and the negative electrode. The separators are arranged between the positive electrode and the negative electrode so that the positive electrode and the negative electrode do not directly oppose each other.

Next, the battery element is enclosed in a casing together with an electrolytic solution, whereby a secondary battery is manufactured.

Although the present invention has been described with reference to one embodiment, the present invention is not limited to the above-described embodiments, and can be arbitrarily changed within the scope of the technical idea of the present invention.

For example, in the above embodiment, the case where the active material layer 111 and the insulating layer 112 are applied to one side of the current collector 110 has been described. However, it is possible to manufacture an electrode having the active material layer 111 and the insulating layer 112 on both surface of the current collector 110 by applying the active material layer 111 and the insulating layer 112 on the other side of the current collector 110 in a similar manner.

Further, the battery obtained by the present invention can be used in various uses. Some examples are described below.

### [Battery Pack]

A plurality of batteries can be combined to form a battery pack. For example, the battery pack may have a configuration in which two or more batteries according to the present embodiment are connected in series and/or in parallel. The series number and parallel number of the batteries can be appropriately selected according to the intended voltage and capacity of the battery pack.

### [Vehicle]

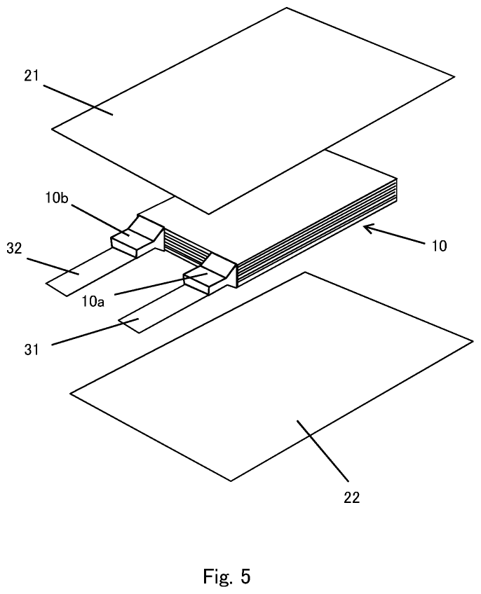

The above-described battery or the battery pack thereof can be used for a vehicle. Examples of vehicles that can use batteries or assembled batteries include hybrid vehicles, fuel cell vehicles, and electric vehicles (four-wheel vehicles (commercial vehicles such as passenger cars, trucks and buses, and mini-vehicles, etc.), motorcycles (motorbike and tricycles). Note that the vehicle according to the present embodiment is not limited to an automobile, and the battery can also be used as various power sources for other vehicles, for example, transportations such as electric trains. As an example of such a vehicle, FIG. 6 shows a schematic diagram of an electric vehicle. The electric vehicle 200 shown in FIG. 6 has a battery pack 210 configured to satisfy the required voltage and capacity by connecting a plurality of the above-described batteries in series and in parallel.

### [Power Storage Device]

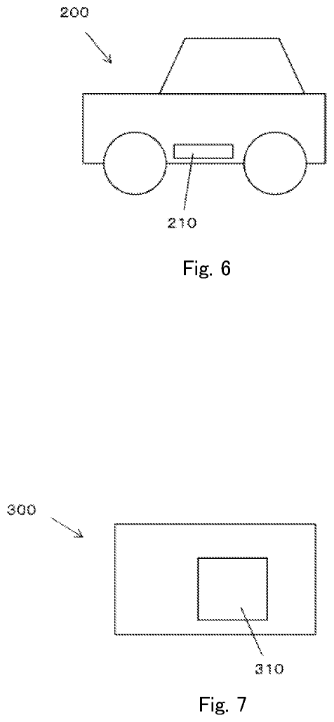

The above-described battery or the battery pack thereof can be used for a power storage device. Examples of the power storage device using the secondary battery or the battery pack thereof include a power storage device which is connected between a commercial power supply supplied to an ordinary household and a load such as a household electric appliance to use as a backup power source or an auxiliary power source in case of power outage, and a power storage device used for large-scale electric power storage for stabilizing electric power output with large time variation due to renewable energy such as photovoltaic power generation. An example of such a power storage device is schematically shown in FIG. 7. The power storage device 300 shown in FIG. 7 has a battery pack 310 configured to satisfy a required voltage and capacity by connecting a plurality of the above-described batteries in series and in parallel.

### [Others]

Furthermore, the above-described battery or the battery pack thereof can be used as a power source of a mobile device such as a mobile phone, a notebook computer and the like.

The present invention will now be described by way of specific examples. However, the present invention is not limited to the following examples.

<Manufacture of Secondary Battery>

### EXAMPLE 1

(Positive Electrode)

Lithium nickel composite oxide (LiNi_{0.80}Mn_{0.15}Co_{0.05}O₂) as a positive electrode active material, carbon black as a conductive auxiliary, and polyvinylidene fluoride as a binder are weighed at a mass ratio of 90:5:5, and they were kneaded using N-methyl pyrrolidone to prepare a positive electrode slurry. The prepared positive electrode slurry was applied to a 20 μm thick aluminum foil as a current collector, dried, and pressed to obtain a positive electrode.

(Preparation of Insulating Layer Slurry)

Next, alumina (average particle diameter 0.7 μm) and polyvinylidene fluoride (PVdF) as a binder were weighted at a weight ratio of 90:10, and they were knead using N-methylpyrrolidone to obtain an insulating layer slurry.

### (Insulating Layer Coating to Positive Electrode)

The prepared insulating layer slurry was applied onto the positive electrode with a die coater, dried, and pressed to obtain a positive electrode coated with the insulating layer. When the section thereof was observed with an electron microscope, the average thickness of the insulating layer was 5 μm. The porosity of the insulating layer calculated from the average thickness of the insulating layer and the true density and composition ratio of each material constituting the insulating layer was 0.55.

### (Negative Electrode)

Artificial graphite particles (average particle diameter 8 μm) as a carbon material, carbon black as a conductive auxiliary and the mixture of styrene-butadiene copolymer rubber:carboxymethyl cellulose in a mass ratio of 1:1 were weighed at a mass ratio of 97:1:2, and they were kneaded using distilled water to obtain a negative electrode slurry. The prepared negative electrode slurry was applied to a copper foil with a thickness of 15 μm as a current collector, dried, and pressed to obtain a negative electrode.

(Assembly of Secondary Battery)

The prepared positive electrode and negative electrode were laminated with a separator interposed therebetween to prepare an electrode laminate. A single-layer PET non-woven fabric was used as the separator. The PET non-woven fabric had a thickness of 15 μm, a porosity of 55%, and a Gurley value of 0.3 seconds/100 ml. The heat shrinkage rate of the used PET non-woven fabric at 200° C. was 4.7%. The number of laminations was adjusted so that the first discharge of the electrode laminate became 10000 mAh. Next, a current collection portion of each of the positive electrode and the negative electrode was bundled, and an aluminum terminal and a nickel terminal were welded to prepare an electrode element. The electrode element was covered with a laminate film, and an electrolytic solution was injected into the laminate film.

Thereafter, while the inside of the laminate film was decompressed, the laminate film was thermally fused and sealed. As a result, a plurality of flat type secondary batteries before initial charge were prepared. The laminated film used was a polypropylene film deposited with aluminum. The electrolytic solution used was a solution containing 1.0 mol/l of LiPF₆ as an electrolytic solution and a mixed solvent of ethylene carbonate and diethyl carbonate (7:3 (volume ratio)) as a non-aqueous electrolytic solvent.

### COMPARATIVE EXAMPLE 1

A secondary battery was prepared under the same conditions as in Example 1 except that PP was used as a separator. The PP used had a Gurley value of 200 seconds/100 ml, and a heat shrinkage rate of 90% or more at 200° C.

<Evaluation of Secondary Battery>

### [Nail Penetration Test]

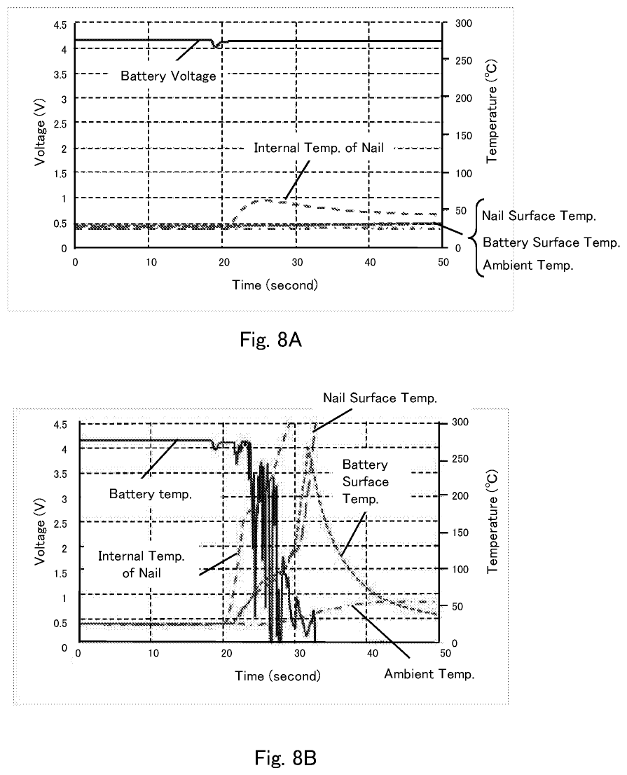

The secondary batteries prepared in Example 1 and Comparative Example 1 were charged to 4.2V and then they were subjected to a nail penetration test by penetrating a nail having a diameter of 3 mm and a nail tip angle of 30 degrees at a speed of 10 mm/sec to the central part of the secondary battery. In the nail penetration test, temporal changes immediately after the start of the test of the battery voltage, the internal temperature of the nail, the nail surface temperature, the battery surface temperature, and the ambient temperature were measured to evaluate the safety of the secondary battery. FIG. 8A shows a graph of temporal changes of battery voltage and temperatures of each part of the secondary battery during the nail penetration test of Example 1, and FIG. 8B shows a graph of temporal changes of the battery voltage and temperatures of each part of the secondary battery during the nail penetration test of Comparative Example 1.

In the secondary battery according to Example 1, as apparent from FIG. 8A, although the battery voltage was temporarily reduced by about 0.1V about 20 seconds after the start of the test, it returned to the original voltage immediately. In addition, the internal temperature of the nail rose to about 60° C. about 20 seconds after the start of the test, but gradually decreased thereafter. The nail surface temperature, the battery surface temperature and the ambient temperature hardly changed.

On the other hand, in the Comparative Example 1, as apparent from FIG. 8B, the battery voltage of the secondary battery decreased after about 20 seconds from the start of the test, and reached about 0V when 40 seconds passed while repeating large fluctuations. As for the temperatures of each part, although the battery surface temperature rose to about 250° C. and then decreased, all of the internal temperature of the nail, the nail surface temperature and the ambient temperature tended to rise with the passage of time.

It is considered that the behavior is different between Example 1 and Comparative Example because, in Example 1, the internal short circuit is only the local short circuit through the nail and the insulating layer and the separator function as insulation as a whole, while in Comparative Example 1, the temperature rise of the separator due to the short circuit through the nail causes the separator to thermally shrink, and the thermal shrinkage of the separator damages the insulating layer, causing the internal short circuit in a wide area. From the above, it is considered that the secondary battery according to Example 1 does not have the possibility of smoke or ignition even if the internal short circuit occurs, but the secondary battery according to Comparative Example 1 may have the possibility of smoke or ignition due to the occurrence of the internal short circuit.

### Further Exemplary Embodiments

The present invention has been described in detail above. The present specification discloses the inventions described in the following further exemplary embodiments. However, the disclosure of the present specification is not limited to the following further exemplary embodiments.

### Further Exemplary Embodiment 1

A secondary battery comprising:

a positive electrode,

a negative electrode disposed to face to the positive electrode, and

a separator disposed between the positive electrode and the negative electrode,

wherein each of the positive electrode and the negative electrode comprises a current collector and an active material layer formed on at least one surface of the current collector, and at least one of the positive electrode and the negative electrode further comprises an insulating layer formed on a surface of the active material layer, and

the separator has a heat shrinkage rate of less than 5% at 200° C. and a Gurley value of 10 seconds/100 ml or less.

### Further Exemplary Embodiment 2

The secondary battery according to Further exemplary embodiment 1, wherein the separator is made of polyethylene terephthalate.

### Further Exemplary Embodiment 3

The secondary battery according to Further exemplary embodiment claim 1 or 2, wherein the separator is a non-woven fabric.

### Further Exemplary Embodiment 4

A method for manufacturing a secondary battery, the method comprising:

disposing a positive electrode and a negative electrode so as to face each other with a separator therebetween to constitute a battery element, and

enclosing the battery element together with an electrolytic solution in a casing,

wherein each of the positive electrode and the negative electrode comprises a current collector and an active material layer formed on at least one surface of the current collector, and at least one of the positive electrode and the negative electrode further comprises an insulating layer formed on a surface of the active material layer, and

the separator has a heat shrinkage rate of less than 5% at 200° C. and a Gurley value of 10 seconds/100 ml or less.

### Further Exemplary Embodiment 5

The method for manufacturing the secondary battery according to Further exemplary embodiment 4, wherein the separator is made of polyethylene terephthalate.

### Further Exemplary Embodiment 6

The method for manufacturing the secondary battery according to Further exemplary embodiment 4 or 5, wherein the separator is a non-woven fabric.

### INDUSTRIAL APPLICABILITY

The secondary battery according to the present invention can be used for all industrial fields requiring power sources and industrial fields related to transportation, storage and supply of electrical energy. More specifically, the battery according to the present invention can be used for power sources for mobile devices such as cellular phone, notebook personal computer; power sources for electric vehicles including electric car, hybrid car, electric motorcycle, power assist bicycle, and transfer/transportation media of trains, satellites and submarines; backup power sources for UPS or the like; electric storage facilities for storing electric power generated by photovoltaic power generation, wind power generation or the like.

### EXPLANATION OF SYMBOLS

10 Battery element
10a Positive electrode tab
10b Negative electrode tab
11 Positive electrode
12 Negative electrode
13 Separator
31 Positive electrode terminal
32 Negative electrode terminal
110 Current collector
110a Extended portion
111 Active material layer
112 Insulating layer

1. A secondary battery comprising:
a positive electrode,
a negative electrode disposed to face to the positive electrode, and
a separator disposed between the positive electrode and the negative electrode,
wherein each of the positive electrode and the negative electrode comprises a current collector and an active material layer formed on at least one surface of the current collector, and at least one of the positive electrode and the negative electrode further comprises an insulating layer formed on a surface of the active material layer, and
the separator has a heat shrinkage rate of less than 5% at 200° C. and a Gurley value of 10 seconds/100 ml or less.

2. The secondary battery according to claim 1, wherein the separator is made of polyethylene terephthalate.

3. The secondary battery according to claim 1, wherein the separator is a non-woven fabric.

4. A method for manufacturing a secondary battery, the method comprising:
disposing a positive electrode and a negative electrode so as to face each other with a separator therebetween to constitute a battery element, and
enclosing the battery element together with an electrolytic solution in a casing,
wherein each of the positive electrode and the negative electrode comprises a current collector and an active material layer formed on at least one surface of the current collector, and at least one of the positive electrode and the negative electrode further comprises an insulating layer formed on a surface of the active material layer, and
the separator has a heat shrinkage rate of less than 5% at 200° C. and a Gurley value of 10 seconds/100 ml or less.

5. The method for manufacturing the secondary battery according to claim 4, wherein the separator is made of polyethylene terephthalate.

6. The method for manufacturing the secondary battery according to claim 4, wherein the separator is a non-woven fabric.
